(19) United States
(12) Patent Application Publication
(10) Pub. No.: US 2026/0028274 A1
(43) Pub. Date: Jan. 29, 2026

(54) PHOSPHOGYPSUM-BASED BUILDING MATERIAL, AND PREPARATION AND USET THEREOF

(71) Applicant: Hubei Juhai Environmental Technology Co., Ltd., Wuhan (CN)

(72) Inventor: Zhihao Liu, Wuhan (CN)

(21) Appl. No.: 19/347,801

(22) Filed: Oct. 2, 2025

Related U.S. Application Data
(63) Continuation of application No. PCT/CN2023/115003, filed on Aug. 25, 2023.

(30) Foreign Application Priority Data
Apr. 27, 2023 (CN) 2023104704281

(51) Int. Cl. C04B 11/024; C04B 11/26

(52) U.S. Cl. CPC C04B 11/024; C04B 11/26

(57) ABSTRACT

The present disclosure belongs to the technical field of harmless treatment of phosphogypsum and building materials, and particularly provides a phosphogypsum-based building material, and preparation and use thereof. The method includes: adding a pretreated phosphogypsum premix having a temperature above 60° C., a free water content ≤10% and an organic matter content of 5-20 wt % into a ceramsite at a temperature above 800° C., continuing mixed calcination after combustion by using residual heat of the ceramsite, separating out ceramsite coarse aggregate to obtain a residual material, and performing post-treatment on the residual material to obtain the phosphogypsum-based building material. The method of the present disclosure not only fully utilizes phosphogypsum solid waste, but also simultaneously achieves harmless treatment of phosphogypsum. More importantly, the method achieves a synergistic enhancement between the ceramsite and phosphogypsum, resulting in the prepared phosphogypsum-based building material with higher strength, a more uniform structure and a wider application range.

### CROSS-REFERENCE TO RELATED APPLICATIONS

This application claims priority to Chinese Patent Application No. 202310470428.1, filed on Apr. 27, 2023, and entitled “Phosphogypsum-based Building Material, and Preparation and Use Thereof”, the entire content of which is incorporated by reference herein.

### TECHNICAL FIELD

The present disclosure relates to the technical field of harmless treatment of phosphogypsum and building materials, and in particular, to a phosphogypsum-based building material, and preparation and use thereof.

### BACKGROUND

The primary step in producing a gypsum building material product from phosphogypsum is to calcine and dehydrate the phosphogypsum to produce gypsum powder. In patent CN 112624642 B, a device for calcining and regenerating phosphogypsum by high-temperature ceramsite and a use method thereof are disclosed. A technical solution for organic integration of technologies including drying and crushing of wet phosphogypsum slag, preheating and dehydration of dry phosphogypsum powder, and cooling of calcined gypsum powder is achieved. On one hand, this solution utilizes the high temperature of the ceramsite to achieve high-temperature dehydration of the phosphogypsum, and on the other hand, it utilizes the porous adsorption properties of the ceramsite to adsorb some harmful substances and evaporated water from the phosphogypsum, thereby purifying the phosphogypsum. Although this method achieves zero-pollution treatment of the phosphogypsum and produces the gypsum powder, it has been found in practice that the phosphogypsum powder, after being fully dehydrated and suspended in a rotary kiln, still has significant room for improvement in performance when applied as a gypsum building material product.

In view of this, the present disclosure is proposed.

### SUMMARY

Through further research on the technical solution in CN 112624642 B, the present disclosure found that the phosphogypsum powder produced by this method did not show significant difference in performance compared to phosphogypsum obtained by drying phosphogypsum slag through other methods. Therefore, the present disclosure provides a phosphogypsum-based building material, and preparation and use thereof. Based on the structural characteristics of ceramsite and phosphogypsum, the process for phosphogypsum dehydration and drying is redesigned to solve the technical challenge in the prior art, where it is difficult to simultaneously achieve the integrated resource utilization and synergistic enhancement of product performance when preparing a gypsum-based building material from phosphogypsum.

Specifically, the present disclosure provides a preparation method of a phosphogypsum-based building material, which includes: mixing a phosphogypsum premix having a temperature above 60° C., a free water content≤10% and an organic matter content of 5-20 wt % with a ceramsite at a temperature above 800° C., continuing mixed calcination after combustion by using residual heat of the ceramsite, separating out coarse aggregate of the ceramsite to obtain a residual material with a ceramic powder content≤30 wt %, and performing post-treatment on the residual material to obtain the phosphogypsum-based building material.

Through further research on the technical solution in CN 112624642 B, the present disclosure observed that a secondary combustion phenomenon occurs when the ceramsite at a temperature above 800° C. comes into contact with the phosphogypsum obtained under a specific condition at a feeding port of a rotary kiln. Furthermore, through many experiments, it was verified that the phosphogypsum premix of the present disclosure is combustible. When added into the ceramsite at a temperature above 800° C., the phosphogypsum premix can be combusted using the residual heat of the ceramsite. Moreover, the combustion process is conducive to achieving efficient harmless treatment of phosphogypsum, especially significantly improving the degree of solidification or passivation of harmful substances. Furthermore, compared with conventional mixed calcination, the residual material obtained from combustion followed by continued mixed calcination in the present disclosure has higher strength, making it more suitable for use as a phosphogypsum-based building material.

The above-mentioned post-treatment process may include: cooling, grinding, and aging the residual material to obtain the phosphogypsum-based building material; or grinding, cooling, and aging the residual material to obtain the phosphogypsum-based building material.

The above-mentioned mixing may be carried out by adding the phosphogypsum premix into the ceramsite at a temperature above 800° C.

According to the preparation method of a phosphogypsum-based building material provided by the present disclosure, both the combustion and continued mixed calcination are carried out in a zero-emission system.

In order to achieve zero emissions, the present disclosure ensures that both the combustion and continued mixed calcination are completed in the zero-emission system (for example, the combustion occurs at the feeding port section of the kiln, and the mixed calcination occurs at the middle and tail ends of the kiln). Furthermore, it was unexpectedly discovered from many experiments that completing the processes in the zero-emission system further improves the strength of the residual material when used as a phosphogypsum-based building material.

According to the preparation method of a phosphogypsum-based building material provided by the present disclosure, the ceramsite has a density of ≤1,200 kg/m³, an average particle size of <31.5 mm, and a porosity of >30%.

According to the experiments of the present disclosure, the porous adsorption properties of the ceramsite can regulate the moisture content in the system. During the process of continued mixed calcination after combustion, the structural parameters of the ceramsite, such as the particle size and pore size, affect the degree of mutual transformation between calcium sulfate dihydrate, calcium sulfate hemihydrate and anhydrous calcium sulfate in the phosphogypsum. Moreover, this regulatory effect is more significant in the zero-emission system. When ceramsite with a density≤1,200 kg/m³, an average particle size <31.5 mm and a porosity >30% is selected, more β-hemihydrate gypsum can be obtained.

According to the preparation method of a phosphogypsum-based building material provided by the present disclosure, the SiO₂ content in the ceramsite is 53-70%.

Preferably, the ceramsite is obtained by mixing, aging, granulating, and calcining the following materials according to a ratio (all percentages by mass):
waste soil 40-70%, sludge 20-50%, phosphogypsum 5-8%, and minerals as balance, where the minerals primarily include: SiO₂ 53-70%, Al₂O₃12-26%, and CaO 3-5%.

The remaining component of the mineral composition primarily consists of one or more of NaO₂, FeO, MgO, and Fe₂O₃, accounting for 8-24%.

The main raw materials for preparing the ceramsite, such as waste soil and sludge, can provide a large amount of SiO₂ after calcination. At the same time, the specific structure and SiO₂ content of the ceramsite can be adjusted by selecting minerals to achieve the purpose of the present disclosure.

Experiments also found that when ceramsite made from a siliceous material is used in the combustion and mixed calcination of the present disclosure, a siliceous phosphogypsum-based building material can be obtained. After high-temperature calcination, the activity of the siliceous phosphogypsum-based building material is further stimulated through a ball milling process. Due to the addition of the siliceous material, the water requirement of the siliceous phosphogypsum-based building material is reduced from 60% to below 40%, and the material becomes more homogeneous, with its strength significantly improved.

According to the preparation method of a phosphogypsum-based building material provided by the present disclosure, the ceramsite is obtained by mixing aging, granulating and calcining waste soil, sludge, phosphogypsum, and minerals at a temperature above 1,100° C.

To make efficient use of energy, the present disclosure directly utilizes the residual heat from the material calcined at the temperature above 1,100° C. to treat a specific phosphogypsum during the cooling process. It was unexpectedly found that this method not only fully utilizes the thermal energy of the system, but also that the uncooled material after calcination exhibits open flame characteristics. When mixed instantly with the specific phosphogypsum premix of the present disclosure, the uncooled material can act as an accelerant, promoting the solidification and passivation of harmful substances in the phosphogypsum premix and improving the mechanical properties of the residual material.

According to the preparation method of a phosphogypsum-based building material provided by the present disclosure, the content of ceramic powder in the residual material is within 10%.

The present disclosure discovered that the strength of the residual material is significantly correlated with the content of ceramic powder in the residual material. In practical applications, by rationally controlling the mass ratio of the phosphogypsum premix and the ceramsite, combining the combustion with the continued mixed calcination process, a better component ratio can be achieved for the residual material. Tests have showed that when the content of ceramic powder in the residual material is controlled within 10%, the resulting phosphogypsum-based building material exhibits a better performance.

According to the preparation method of a phosphogypsum-based building material provided by the present disclosure, the mass content of calcium sulfate dihydrate in the phosphogypsum premix is ≥60%, preferably 60% to 75%.

The key component in the phosphogypsum premix is organic matter, and its main component is calcium sulfate dihydrate. Experiments have found that the content of calcium sulfate dihydrate affects the performance of the final phosphogypsum-based building material. When the mass content of calcium sulfate dihydrate in the phosphogypsum premix is greater than 60%, the combustion and mixed calcination systems become more stable.

According to the preparation method of a phosphogypsum-based building material provided by the present disclosure, the phosphogypsum premix is obtained by heating by-product phosphogypsum slag from the wet phosphoric acid process in the zero-emission system at a temperature above 160° C.

Experiments of the present disclosure have found that treating the by-product phosphogypsum slag from the wet phosphoric acid process, in the zero-emission system can obtain a phosphogypsum premix with a certain amount of free water and organic matter. More importantly, at a higher temperature, the free water in the phosphogypsum premix becomes more active, and the organic matter is more easily combustible, thereby enabling the ceramsite to function more effectively during the combustion and mixed calcination stages.

The zero-emission system in the present disclosure refers to a process in which no gases or impurities are emitted during the reaction process of the materials within the system.

For example, during the continued mixed calcination process of the phosphogypsum premix and ceramsite after combustion, the moisture and impurities in the phosphogypsum premix remain in the whole system all the time, and the ceramic powder produced through friction also remains in the whole system. After the continued mixed calcination process followed by combustion is completed, only two outputs of separated ceramsite coarse aggregate and residual siliceous phosphogypsum-based building material are produced. For example, this process may take place in devices at the middle and tail ends of the rotary kiln for mixed calcination.

For another example, during the preparation process of the phosphogypsum premix from phosphogypsum slag, the free water and impurities generated by heating phosphogypsum slag are not discharged to the outside. Instead, they are thoroughly mixed with the phosphogypsum to form the phosphogypsum premix, which is then added into the ceramsite. This process can occur, for example, in a device at the initial feeding port section of the rotary kiln for mixed calcination.

In the present disclosure, by controlling the feeding of the phosphogypsum slag and the ceramsite, and the discharge of the ceramsite coarse aggregate and the residual material, the entire intermediate process can be maintained in the zero-emission system. This not only allows for full recycling and utilization of the phosphogypsum slag, but also makes efficient use of the system's energy and the interactions between the materials in the system. More importantly, the performance of the resulting phosphogypsum-based building material is significantly superior to industry standards, offering significant substantial application value and technical contributions.

Preferably, the phosphogypsum premix is obtained by heating the by-product phosphogypsum slag from the wet phosphoric acid process under the function of residual heat from the combustion and mixed calcination.

To promote low-carbon and environmental protection, and to make full use of energy, the residual heat from the combustion and mixed calcination can be used to preheat the by-product phosphogypsum slag from the wet phosphoric acid process. In practical applications, a residual heat utilization device can be rationally designed to maximize energy conversion rate.

According to the preparation method of a phosphogypsum-based building material provided by the present disclosure, the combustion is conducted for 3-15 s, and the mixed calcination is conducted for greater than 5 min.

Preferably, the mixed calcination is conducted at a temperature above 400° C.

To better passivate the harmful substances contained in the phosphogypsum, such as soluble phosphorus, soluble fluorine, soluble sodium, soluble magnesium, and various heavy metals, experiments have shown that mixed calcination at a temperature of above 400° C. treats the harmful substances in the phosphogypsum slag to the maximum extent in the production of the building material. This improves the quality and application range of the phosphogypsum-based building material.

In addition, during the mixed calcination process, high-quality zero-carbon emission calcination is realized based on thermal energy conversion efficiency. The feeding amount of phosphogypsum slag is pre-controlled to ensure moisture content and flash combustion quality during pretreatment.

The present disclosure further provides a phosphogypsum-based building material prepared by the above-described preparation method of a phosphogypsum-based building material.

Preferably, the phosphogypsum-based building material contains more than 80% β-hemihydrate gypsum.

More preferably, the phosphogypsum-based building material also contains 5-10% silicate.

The phosphogypsum-based building material prepared by the present disclosure has excellent performance and a wide range of applications, can be used in gypsum-based thermal insulation mortar, and is more suitable for use as a gypsum-based stabilized base material in road engineering.

In the preparation method of a phosphogypsum-based building material of the present disclosure, the separated ceramsite coarse aggregate, due to its characteristics of residual gypsum-based cementing material, can be used in self-insulating wall materials, building blocks, lightweight concrete dry mixes, and other applications in green building projects.

The phosphogypsum-based building material, and the preparation and use thereof, provided by the present disclosure involve mixing the phosphogypsum premix having a temperature above 60° C., a free water content≤10%, and an organic matter content of 5-20 wt % with ceramsite at a temperature above 800° C., and then continuing mixed calcination after using the residual heat of the ceramsite for combustion. This achieves efficient harmless treatment of the phosphogypsum, and particularly, significantly improves the degree of solidification or passivation of the harmful substances. Moreover, compared with conventional mixed calcination, the residual material obtained by the continued mixed calcination followed by combustion in the present disclosure has higher strength, making it more suitable for use as the phosphogypsum-based building material.

### DETAILED DESCRIPTION OF THE EMBODIMENTS

To make the objectives, technical solutions, and advantages of the present disclosure clearer, the technical solutions of the present disclosure will be described clearly and comprehensively below. It is obvious that the described embodiments are only a part of the embodiments of the present disclosure, rather than all of them. Based on the embodiments of the present disclosure, all other embodiments obtained by those of ordinary skill in the art without making creative efforts shall fall within the scope of protection of the present disclosure.

For any technical details or conditions not explicitly specified in the embodiments, reference may be made to techniques or conditions described in documents the field or product manuals. Reagents or instruments that are not marked with a specific manufacturer refer to conventional products available through legitimate commercial channels.

The minerals in the present disclosure are derived from industrial tailing, waste slag, etc., and their main mineral components include: SiO₂ 53-70%, Al₂O₃12-26% and CaO 3-5%. The remaining components are mainly NaO₂, FeO, MgO and Fe₂O₃, accounting for 8-24%.

### Example 1

A preparation method of a phosphogypsum-based building material, with the process as follows:
(1) carrying out heating pre-treatment on phosphogypsum to obtain a phosphogypsum premix having a temperature of 70° C., a free water content of 10%, and an organic matter content of 15%, wherein the mass content of calcium sulfate dihydrate in the phosphogypsum premix is 60%;
mixing 60% of waste soil, 30% of sludge, 5% of phosphogypsum, and the balance of minerals according to a ratio, and aging, granulating, and calcining at a high temperature to obtain ceramsite (calcination temperature was 1,100° C.);
(2) adding the phosphogypsum premix in step (1) into the ceramsite obtained after high-temperature calcination in step (1); at this time, ensuring that the temperature of the ceramsite is above 800° C. when added; continuing mixed calcination after combustion using the residual heat of the ceramsite; separating out the ceramsite coarse aggregate with an average particle size of above 2.36 mm, where the content of ceramic powder in the obtained residual material was 5%; and further grinding, cooling, and aging the obtained residual material to obtain the phosphogypsum-based building material, where
the SiO₂ content in the ceramsite was 65%, the density of the ceramsite was 450 kg/m³, the average particle size was 30 mm, the porosity was 45%, and the mass ratio of the phosphogypsum premix to the ceramsite was 1:1. In the absence of external heating, the phosphogypsum premix and the ceramsite continue combustion for 10 s, the mixed calcination time was controlled to 10 min, and the material temperature gradually reached 400-600° C. after a rapid rise.

The prepared phosphogypsum-based building material was tested, and the test results showed that the phosphogypsum-based building material contained 82% of β-hemihydrate gypsum and 5% of silicate; and the strength of the phosphogypsum-based building material reached grade 3.0.

The present disclosure also analyzed the above-mentioned phosphogypsum premix and the prepared phosphogypsum-based building material. It was found that the contents of some elements changed significantly, as detailed below:

| | | Content (%) in |
|---|---|---|
| | Content (%) in | phosphogypsum-based |
| Components | phosphogypsum premix | building material |
| P₂O₅ | 0.627 | 0.16 |
| F⁻ | 0.331 | 0.064 |
| Na | 0.14 | 0.022 |
| Mg | 0.17 | 0.048 |

The present disclosure also tested the acidity and alkalinity of the above-mentioned phosphogypsum premix and the prepared phosphogypsum-based building material. It was found that the pH value of the phosphogypsum-based building material was significantly higher than that of the phosphogypsum premix, increasing to above 7.

### Example 2

A preparation method of a phosphogypsum-based building material has a process similar to Example 1, with the difference being that ceramsite coarse aggregate with an average particle size of above 5 mm was separated, so that the content of ceramic powder in the obtained residual material was 10%.

### Example 3

A preparation method of a phosphogypsum-based building material has a process similar to Example 1, with the difference being that ceramsite coarse aggregate with an average particle size of above 8 mm was separated, so that the content of ceramic powder in the obtained residual material was 20%.

### Example 4

A preparation method of a phosphogypsum-based building material has a process similar to Example 1, with the difference being that ceramsite coarse aggregate with an average particle size of above 10 mm was separated, so that the content of ceramic powder in the obtained residual material was 30%.

The strength of the phosphogypsum-based building materials obtained in Examples 1-4 was tested, with the test results as follows:

Strength (MPa)

| | 2 h Flexural strength | 2 h Compressive strength |
|---|---|---|
| Example 1 | 3.7 | 7.9 |
| Example 2 | 3.3 | 7.8 |
| Example 3 | 2.5 | 6.4 |
| Example 4 | 1.9 | 5.3 |

### Example 5

A preparation method of a phosphogypsum-based building material has a process similar to Example 1, with the difference being that the phosphogypsum premix was obtained by heating by-product phosphogypsum slag from the wet phosphoric acid process at 160° C. in a zero-emission system. The phosphogypsum slag was sourced from a phosphogypsum storage yard, and the mass content of calcium sulfate dihydrate in the obtained phosphogypsum premix was 50%.

The results showed that the strength of the prepared phosphogypsum-based building material was significantly reduced compared to Example 1. Specifically, a 2-hour flexural strength was 1.6 MPa and a 2-hour compressive strength was 4.3 MPa.

### Example 6

A preparation method of a phosphogypsum-based building material has a process similar to Example 1, with the difference being that the content of SiO₂ in minerals was adjusted, so that the content of SiO₂ in ceramsite was 70%.

The results showed that the prepared phosphogypsum-based building material contained 5-7% silicate; and the 2-hour strength of the phosphogypsum-based building material was 8.75 MPa in compressive strength and 3.85 MPa in flexural strength.

### Example 7

A preparation method of a phosphogypsum-based building material has a process similar to Example 1, with the difference being that the processing technology for ceramsite was adjusted to achieve a porosity of approximately 20%.

The results showed that the prepared phosphogypsum-based building material contained 65% β-hemihydrate gypsum.

### Example 8

A preparation method of a phosphogypsum-based building material has, the basic same process as Example 1, with the difference only being that the combustion and continued mixed calcination were both conducted in a zero-emission system.

The results showed that the prepared phosphogypsum-based building material contained 86% β-hemihydrate gypsum.

### Example 9

A preparation method of a phosphogypsum-based building material has a process similar to Example 5, with the difference being that the phosphogypsum premix was obtained by heating by-product phosphogypsum slag from the wet phosphoric acid process under function of residual heat from the combustion and the mixed calcination.

### Contrast 1

A preparation method of a phosphogypsum-based building material has a process similar to Example 1, with the difference being that the phosphogypsum premix in step (1) was cooled to 50° C. and then added to the ceramsite obtained after high-temperature calcination in step (1). The results showed that the strength of the obtained phosphogypsum-based building material decreased. By analyzing the residual material, it was found that the content of ceramic power in the residual material was too high, while the content of β-hemihydrate gypsum was too low.

### Contrast 2

A preparation method of a phosphogypsum-based building material has a process similar to Example 1, with the difference being that the free water content in phosphogypsum premix was 50%. The results showed that when it came into contact with ceramsite, combustion could not occur, the strength of the obtained phosphogypsum-based building material decreased, and the content of harmful components and impurities was too high.

### Contrast 3

A preparation method of a phosphogypsum-based building material has a process similar to Example 1, with the difference being that the phosphogypsum premix in step (1) was added to the ceramsite obtained after high-temperature calcination in step (1) and having a temperature of 750° C. It was found that no combustion phenomenon occurred at the feeding port, and no secondary temperature rise phenomenon occurred during the combustion of organic matter. When the proportion of β-hemihydrate gypsum reached more than 80%, the mixed calcination time needed to be extended to 30 minutes or more, and the feeding ratio of the phosphogypsum premix was changed from 1:1 to 0.8:1 or below. The β-hemihydrate gypsum conversion rate dropped significantly, and the mixed calcination temperature showed a linear decay state, leading to a significant drop in efficiency.

Finally, it should be noted that the above embodiments are only used to illustrate the technical solutions of the present disclosure, and are not intended to limit it. Although the present disclosure has been described in detail with reference to the aforementioned embodiments, those skilled in the art should understand that they can still modify the technical solutions described in the aforementioned embodiments, or make equivalent replacements for some of the technical features therein. These modifications or replacements do not deviate the essence of the corresponding technical solutions from the spirit and scope of the technical solutions of the various embodiments of the present disclosure.

What is claimed is:

1. A preparation method of a phosphogypsum-based building material, comprising: mixing a phosphogypsum premix having a temperature above 60° C., a free water content ≤10% and an organic matter content of 5-20 wt % with a ceramsite at a temperature above 800° C., continuing mixed calcination after combustion by using residual heat of the ceramsite, separating out ceramsite coarse aggregate to obtain a residual material with a ceramic powder content≤30 wt %, and performing post-treatment on the residual material to obtain the phosphogypsum-based building material.

2. The preparation method of a phosphogypsum-based building material according to claim 1, wherein both the combustion and continued mixed calcination are carried out in a zero-emission system.

3. The preparation method of a phosphogypsum-based building material according to claim 1, wherein the ceramsite has a density≤1,200 kg/m³, an average particle size <31.5 mm, and a porosity >30%.

4. The preparation method of a phosphogypsum-based building material according to claim 1, wherein the content of SiO₂ in the ceramsite is 53-70%.

5. The preparation method of a phosphogypsum-based building material according to claim 1, wherein the ceramsite is obtained by mixing, aging, granulating, and calcining the following materials:
waste soil 40-70%, sludge 20-50%, phosphogypsum 5-8%, and minerals as balance.

6. The preparation method of a phosphogypsum-based building material according to claim 5, wherein the ceramsite is obtained by mixing, aging, granulating, and calcining waste soil, sludge, phosphogypsum, and minerals at a temperature of above 1,100° C.

7. The preparation method of a phosphogypsum-based building material according to claim 1, wherein the content of ceramic powder in the residual material is 5-10%.

8. The preparation method of a phosphogypsum-based building material according to claim 1, wherein the mass content of calcium sulfate dihydrate in the phosphogypsum premix is greater than 60%.

9. The preparation method of a phosphogypsum-based building material according to claim 1, wherein the phosphogypsum premix is obtained by heating by-product phosphogypsum slag from a wet phosphoric acid process in a zero-emission system at a temperature of above 160° C.

10. The preparation method of a phosphogypsum-based building material according to claim 9, wherein the phosphogypsum premix is obtained by heating the by-product phosphogypsum slag from the wet phosphoric acid process under the function of residual heat from the combustion and the mixed calcination.

11. The preparation method of a phosphogypsum-based building material according to claim 1, wherein the combustion is conducted for 3-15 s, and the mixed calcination is conducted for greater than 5 min, and mixed calcination is conducted at a temperature above 400° C.

12. A phosphogypsum-based building material, prepared by the preparation method of a phosphogypsum-based building material in any one of claims 1 to 11.

13. Use of a phosphogypsum-based building material, applying the phosphogypsum-based building material described in claim 12.
